(19) United States
(12) Patent Application Publication
(10) Pub. No.: US 2009/0112855 A1
(43) Pub. Date: Apr. 30, 2009

(54) METHOD FOR ORDERING A SEARCH RESULT AND AN ORDERING APPARATUS

(75) Inventors: Qi Guo, Beijing (CN); Gang SG Shi, Beijing (CN)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: International Business Machines Corporation, Armonk, NY (US)

(21) Appl. No.: 12/261,491

(22) Filed: Oct. 30, 2008

(30) Foreign Application Priority Data
Oct. 30, 2007 (CN) 200710184962.7

(51) Int. Cl. G06F 17/30

(52) U.S. Cl. 707/5; 707/E17.014

(57) ABSTRACT

A method for ordering a search result, wherein the search result comprises a plurality of data unit candidates from hierarchical data which further comprises a data unit corresponding to a search requester, the method comprising: calculating a relative distance between the data unit of the search requester and each of the plurality of data unit candidates according to the hierarchical data, the relative distance representing relativity between the data units in the hierarchical data; and ordering the plurality of data unit candidates according to the relative distances. The present invention can order the data unit candidates according to the relativity between the data unit candidates and the data unit of the search requester in the hierarchical data so that the search requester can quickly determine the most concerned data unit candidate. The present invention also provides a corresponding ordering apparatus as well as a searching method based on hierarchical data and a searching engine.

### CROSS REFERENCE TO RELATED APPLICATION

The present application claims the benefit of priority to a Chinese Patent Application Serial Number 200710184962.7 entitled “A METHOD FOR ORDERING A SEARCH RESULT AND AN ORDERING APPARATUS”, filed Oct. 30, 2007 with the State Intellectual Property Office (SIPO) of the People's Republic of China, the content of which is incorporated herein by reference in its entirety.

### TECHNICAL FIELD OF THE INVENTION

The present invention relates to data ordering technique, particularly to a method for ordering a search result and an ordering apparatus, and a searching method based on hierarchical data and a searching engine.

### BACKGROUND OF THE INVENTION

In a computer network of a large-scale organization such as a company or a school, there always is a directory server which can be used to provide electronic directory services, such as user information searching. When a user searches in the directory server for another person by using client programs, the user enters relative search criteria, for example, name, mail address, telephone number, etc. The client program can be an email client program, or a website providing the directory, for example Lotus Notes and Blue Page provided by IBM Corporation. Then, the directory server makes a search according to the search criteria and returns a search result to the user.

However, sometimes the user can only provide partial and incomplete information as the search criteria. It will result in multiple records which match the search criteria. In addition, if the searched target has duplicate information with other persons, such as the same first name or last name, it will also result in more than one record returned. In general, if the search result includes a plurality of records, the plurality of records would be ordered alphabetically. The user needs to browse the search result to select the desired record which maybe appears in the lower place.

A similar scenario happens in the use of email client programs. For example, when using the Lotus Notes enterprise email system to send an email, if the user only enters the partial names or names which have duplicates, a list comprising a plurality of names which match the input will appear. The user needs to select the desired name from the list in which the names are ordered alphabetically. Thus, it is possible that the name which the user wants to find appears in the lower space of the list, which makes operation by the user inconvenient. Especially, when a user needs to send many emails to a certain person or a group of persons very often, he/she must browse the name list each time and doing selection. Such browsing and selecting operations could be time consuming and bring low efficiency.

In addition, there always would be another scenario where the user who initiates a search request wants to find persons in the same department or organization as him, and thus the target persons are required to appear on the top of the result list. However, in the prior art, the result list is ordered alphabetically.

Therefore, it is expected to provide a technical solution which may assist the user who initiates the search request find the desired records quickly, i.e. the most relative records are positioned on the top of the result list.

A reference “RFC 2891-LDAP Control Extension for Server Side Sorting of Search Results” provides an ordering control for search results at a server side, wherein one or several ordering keys are used to designate the ordering criteria. However, the ordering control is limited to the existing ordering keys and the relationship between the user who initiates the search request and the records are not used.

### SUMMARY OF THE INVENTION

The present invention is directed to above technical problems, and its objective is to provide a method for ordering a search result and an ordering apparatus, which can order the search result in use of relations between respective data units in hierarchical data so as to facilitate the search requester to find the most relevant data units quickly and thereby improve efficiency. Additionally, the present invention also provides a searching method based on hierarchical data and a search engine.

According to first embodiment of the present invention, it is provided with a method for ordering a search result, wherein the search result comprises a plurality of data unit candidates from hierarchical data which further comprises a data unit corresponding to a search requester, the method comprises: calculating a relative distance between the data unit of the search requester and each of the plurality of data unit candidates according to the hierarchical data, the relative distance representing relativity between the data units in the hierarchical data; and ordering the plurality of data unit candidates according to the relative distances.

According to another embodiment of the present invention, the embodiment provides an ordering apparatus for ordering a search result, wherein the search result comprises a plurality of data unit candidates from hierarchical data which further comprises a data unit corresponding to a search requester, the ordering apparatus comprises: a relative distance calculation unit for calculating a relative distance between the data unit of the search requester and each of the plurality of data unit candidates according to the hierarchical data, the relative distance representing relativity between the data units in the hierarchical data; and an ordering unit for ordering the plurality of data unit candidates according to the relative distances.

According to another embodiment of the present invention, the embodiment provides a searching method based on hierarchical data, wherein the hierarchical data comprises a data unit corresponding to a search requester, the searching method comprises: receiving a search request from the search requester, the search request containing identification information which uniquely identifies the search requester and search criteria; searching the data unit of the search requester corresponding to the identification information and a search result which matches the search criteria in the hierarchical data based on the search request; and ordering the search result by using the method for ordering a search result.

According to another embodiment of the present invention, the embodiment provides a searching engine based on hierarchical data, wherein the hierarchical data comprises a data unit corresponding to a search requester, the searching engine comprises: a search request receiving apparatus for receiving a search request from the search requester, the search request comprising identification information which uniquely identifies the search requester and search criteria; a searching apparatus for searching the data unit of the search requester corresponding to the identification information and a search result which matches the search criteria in the hierarchical data based on the search request; and an ordering apparatus for ordering a search result, for ordering the search result.

### BRIEF DESCRIPTION OF THE DRAWINGS

FIG. 1 is a flowchart showing a method for ordering a search result according to one embodiment of the present invention;

FIG. 2 is a flowchart of a method for ordering a search result according to another embodiment of the present invention;

FIG. 3 is a flowchart of a method for ordering a search result according to another embodiment of the present invention;

FIG. 4 is a flowchart of a searching method based on hierarchical data according to another embodiment of the present invention;

FIG. 5 is a schematic diagram showing an example of the hierarchical data;

FIG. 6 is a schematic block diagram showing an ordering apparatus for ordering a search result according to one embodiment of the present invention;

FIG. 7 is a schematic block diagram showing an ordering apparatus for ordering a search result according to another embodiment of the present invention;

FIG. 8 is a schematic block diagram showing an ordering apparatus for ordering a search result according to another embodiment of the present invention;

FIG. 9 is a schematic block diagram showing a searching engine based on hierarchical data according to another embodiment of the present invention.

### DETAILED DESCRIPTION OF THE INVENTION

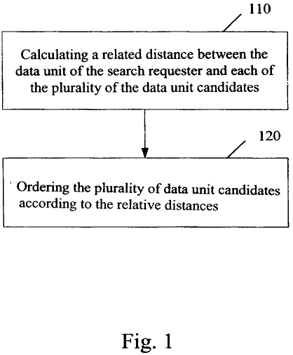

FIG. 1 is a flowchart showing a method for ordering a search result according to one embodiment of the present invention. This embodiment is described in conjunction with the figures.

In this embodiment, the search result is obtained by searching hierarchical data according to a request from a search requester, and search result comprises a plurality of data unit candidates from the hierarchical data. Furthermore, the hierarchical data also comprises a data unit corresponding to the search requester (hereinafter called “the data unit of the search requester”).

As shown in FIG. 1, after the search result is obtained from the hierarchical data, at Step 110, a relative distance between the data unit of the search requester and each of the plurality of data unit candidates is calculated according to the hierarchical data, and becomes a criterion for ordering the search result. In the hierarchical data, the relationship (relativity) between the respective data units can be represented by the relative distance between them, and the shorter the relative distance between two data unit is, the more relative the two data units are.

After the relative distances between the data unit of the search requester and the plurality of data unit candidates are obtained, at Step 120, the plurality of data unit candidates in the search result are ordered according to the relative distances calculated in Step 110. For example, the plurality of data unit candidates in the search results is ordered in an ascending sequence based on the relative distances. In this way, the data unit candidate which is most relative to the data unit of the search requester is positioned on the top of the search result, thereby facilitating further operations of the search requester.

It can be seen from the above description that the method for ordering a search result of this embodiment can use the relationship between the data unit of the search requester and the data unit candidates in the search result in the hierarchical data to order the data unit candidates, so that the search requester can quickly determine the most concerned data unit candidate.

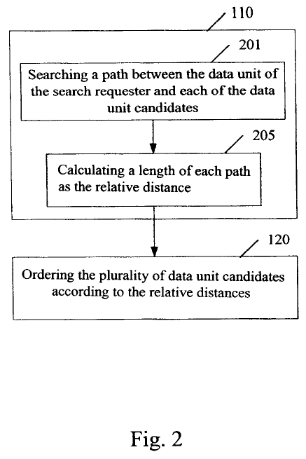

FIG. 2 is a flowchart of a method for ordering a search result according to another embodiment of the present invention, wherein the same parts as those of the previous embodiment use the same reference numbers and their description are omitted properly. This embodiment will be described in detail as follows in conjunction with the figure.

In this embodiment, when the relative distances between the data unit of the search requester and the plurality of data unit candidates are calculated (Step 110), firstly at Step 201, a path between the data unit of the search requester and each of the plurality of data unit candidates is searched in the hierarchical data; and then at Step 205, the length of the respective paths is calculated as the relative distance between the data unit of the search requester and each of the plurality of data unit candidates.

Then, at Step 120, based on the respective relative distances obtained at Step 205, the data unit candidates are ordered in an ascending sequence. In this way, the data unit candidate which is most relevant to the data unit of the search requester in the search result is positioned on the top of the search result.

It can be seen from the above description that the method for ordering a search result of this embodiment further defines the relative distance as the length of the path between the data unit of the search requester and the data unit candidate to determine the data unit candidate which is most relevant to the data unit of the search requester.

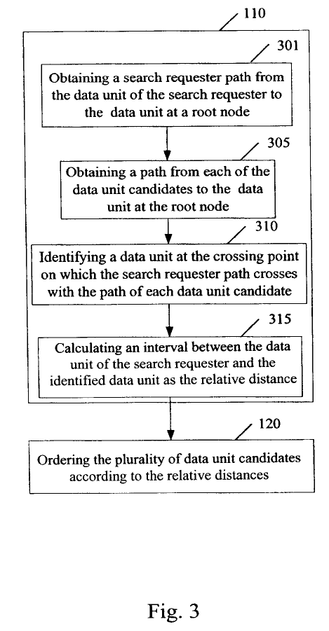

FIG. 3 is a flowchart of a method for ordering a search result according to another embodiment of the present invention, wherein the same parts as those of the previous embodiments use the same reference numbers and their description are omitted properly. This embodiment will be described in detail as follows in conjunction with the figure.

In this embodiment, a “path-backing-up” method is used in the Step 110 to calculate the relative distance between the data unit of the search requester and each of the plurality of data unit candidates.

Specifically, firstly at Step 301, a path from the data unit of the search requester to a data unit at a root node is obtained from the hierarchical data, as a search requester path. Secondly at Step 305, the path from each of the plurality of data unit candidates to the data unit at the root node is obtained from the hierarchical data, i.e. a plurality of paths of the data unit candidates are obtained. Then, at Step 310, the data unit at a crossing node on which the search requester path crosses with each of the paths of the data unit candidates is identified, that is, the data unit at the common ancestor node of the data unit of the search requester and each of the data unit candidates is identified. Finally at Step 315, for each of the identified data units at the crossing points, an interval between the data unit of the search requester and the identified data unit is calculated as the relative distance between the data unit of the search requester and the corresponding data unit candidate.

Then, at Step 120, the plurality of data unit candidates are ordered in an ascending sequence based on the relative distances obtained at Step 315. In this way, the data unit candidate which is most relevant to the data unit of the search requester is positioned on the top of the search result.

It can be seen from the above description that the method for ordering a search result of this embodiment can calculate the relative distances between the data unit of the search requester and the data unit candidates by using the “path-backing-up” method, so that the data unit candidate which is most relevant to the data unit of the search requester can be positioned more accurately.

It can be understood by the persons skilled in the art that the relative distances between the data unit of the search requester and the data unit candidates can be calculated by using any one of the above methods for calculating the relative distances. Certainly, other methods for calculating the relative distances can be used.

In the above embodiment, the criterion for ordering the search result is the relative distance between the data unit of the search requester and each of the data unit candidates in the search result in the hierarchical data.

Further, in another embodiment, weights of the data unit candidates can be included in the criterion for ordering the search result, i.e. the search result can further include the weight corresponding to each of the plurality of data unit candidates. In this case, after Step 110, the plurality of data unit candidates are ordered according to the relative distance between the data unit of the search requester and each of the plurality of data unit candidates, and the weight corresponding to each of the data unit candidates. For example, for each data unit candidate, a weighted value can be calculated based on the weight of the data unit candidate and the relative distance between the data unit candidate and the data unit of the search requester. Weighting factors for the weight and the relative distance can be pre-determined. Then at Step 120, the plurality of data unit candidates are ordered in an ascending sequence based on the weighted values.

Further, in another embodiment, an attribute of the data unit in the hierarchical data can be included in the criterion for ordering the search result. Specifically, the data unit candidates having the same attribute as the data unit of the search requester are searched in the plurality of data unit candidates. For example, if the attribute of the data unit of the search requester is “engineer”, the data unit candidates having the attribute of “engineer” are searched in the plurality of data unit candidates. Then in the ordering step (Step 120), the data unit candidates having the same attribute as the data unit of the search requester and the remaining data unit candidates are ordered separately. The persons skilled in the art can understand that the above searching step can be executed either before the calculating step (Step 110) or after the calculating step (Step 110).

Further, in another embodiment, a combination of the weights of the data unit candidates and the attributes of the data units can be included in the criterion for ordering the search result. It is obvious to the persons skilled in the art and thus the description is omitted.

The persons skilled in the art can understand that the method for ordering a search result in the above embodiments can be used individually, or can be combined with the existing searching method and directory service software.

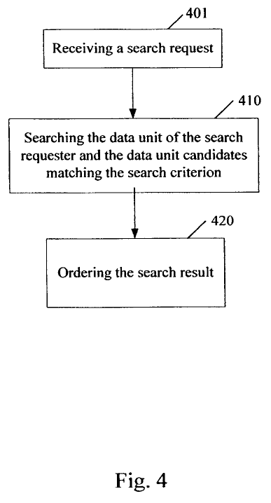

Under the same inventive concept, FIG. 4 is a flowchart of a searching method based on hierarchical data according to one embodiment of the present invention. The descriptions of the portions which are same as those of the previous embodiments are omitted properly. This embodiment will be described in detail in conjunction with the figure.

In this embodiment, the hierarchical data includes a data unit corresponding to a search requester, i.e. the data unit of the search requester.

As shown in FIG. 4, at Step 401, a search request initiated by the search requester is received. The search request comprises identification information which uniquely identifies the search requester and a search criterion. The identification information is used for determining the data unit of the search requester in the hierarchical data. The identification information can be an entire mail address of the search requester, a user ID and so on.

Then, at Step 410, the data unit of the search requester corresponding to the identification information and the search result matching the search criterion are searched in the hierarchical data. The search result comprises a plurality of data unit candidates. This step can be executed by using the existing data searching techniques, such as a fuzzy matching method, a precise matching method, etc. The existing data searching techniques are known to the persons skilled in the art and thus the relative descriptions are omitted properly.

The plurality of data unit candidates in the search result obtained in Step 410 are not ordered or ordered alphabetically.

Then at Step 420, the obtained data unit candidates in the search result are ordered by using any one of the methods for ordering the search result as shown in FIGS. 1, 2 and 3. The ordered search result is returned to the search requester in a list.

The persons skilled in the art can understand that the searching method based on hierarchical data of this embodiment can be used individually, or can be combined with the existing directory service software.

It can be seen from the above description that the searching method based on the hierarchical data of this embodiment not only can search in the hierarchical data for the data unit candidates matching the search criterion, but also can order the data unit candidates according to the relativity between the data unit of the search requester and the data unit candidates in the hierarchical data so as to enable the search requester to find the desired data unit candidate quickly and to improve the efficiency.

In the above embodiment, the hierarchical data can be tree structure data, for example, an organizational hierarchy. The specified application of the embodiment shown in FIG. 3 is described as follows in conjunction with the organizational hierarchy.

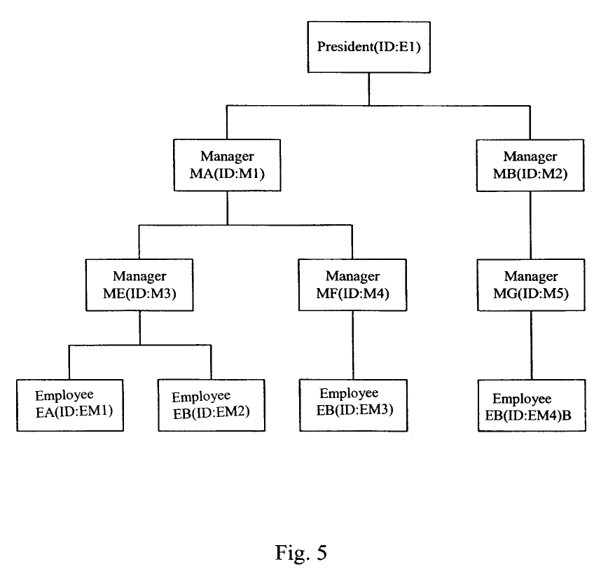

FIG. 5 is a schematic diagram showing an example of the hierarchical data, i.e. the organizational hierarchy, which is stored in a directory server. As shown in FIG. 5, the data unit at a root node in the hierarchical data (organizational hierarchy) is “President (ID:E1)”, which has two sub-node data units “Manager MA(ID:M1)” and “Manager MB(ID:M2).” The sub-node data units of the data unit “Manager MA(ID:M1)” are “Manager ME(ID:M3)” and “Manager MF(ID:M4)”, and the sub-node data unit of the data unit “Manager MB(ID:M2)” is “Manager MG(ID:M5)”. The sub-node data units of the data unit “Manager ME(ID:M3)” are “Employee EA(ID:EM1)” and “Employee EB(ID:EM2)”. The sub-node data unit of the data unit “Manager MF(ID:M4)” is “Employee EB(ID:EM3)”, and the sub-node data unit of the data unit “Manager MG(ID:M5)” is “Employee EB(ID:EM4)”. It can be seen that three employees have the same name “EB” in the organizational hierarchy.

If the employee EA wants to search the employee EB in the same department, he/she inputs “EB” as the search criterion. Both the search criterion “EB” and the identification information “ID:EM1” of the employee EA are submitted to the directory server as the search request. The directory server searches in the organizational hierarchy according to the search request and obtains the data unit “Employee EA (ID:EM1)” and three data unit candidates “Employee EB(ID:EM2)”, “Employee EB(ID:EM3)” and “Employee EB(ID:EM4)” which match the search criterion “EB”.

Then, the paths from the data unit of the employee EA and three data unit candidates to the data unit at the root node are acquired as follows:

The path from the data unit of the employee EA “Employee EA (ID:EM1)” to the data unit at the root node “President (ID:E1)” is: EM1-M3-M1-E1;

The path from the data unit candidate “Employee EB (ID:EM2)” to the data unit at the root node “President (ID:E1)” is: EM2-M3-M1-E1;

The path from the data unit candidate “Employee EB (ID:EM3)” to the data unit at the root node “President (ID:E1)” is: EM3-M4-M1-E1; and

The path from the data unit candidate “Employee EB (ID:EM4)” to the data unit at the root node “President (ID:E1)” is: EM4-M5-M2-E1.

In this way, the data units at the crossing points on which the paths from the data unit of the employee EA to the data unit at the root node crosses with three paths from the data unit candidates to the data unit at the root node respectively can be obtained. They are the data units “Manager ME (ID:M3)”, “Manager MA (ID:M1)” and “President (ID:E1).”

Then, the intervals between the data unit of the employee EA and the respective data units at the crossing points are calculated as the relative distances between the data unit of the employee EA and the respective data unit candidates. Thus, the relative distance between the data unit of the employee EA “Employee EA (ID:EM1)” and the data unit candidate “Employee EB (ID:EM2)” is 1; the relative distance between the data unit of the employee EA “Employee EA (ID:EM1)” and the data unit candidate “Employee EB (ID:EM3)” is 2; and the relative distance between the data unit of the employee EA “Employee EA (ID:EM4)” and the data unit candidate “Employee EB (ID:EM2)” is 3.

Then, the three data unit candidates are ordered in an ascending sequence based on the relative distances as a list of the search result, i.e. “Employee EB(ID:EM2)”, “Employee EB(ID:EM3)” and “Employee EB(ID:EM4)”. As a result, the employee “Employee EB(ID:EM2)” in the same department as the employee EA is positioned on the top of the list. Finally, the list of the search result is returned to the employee EA.

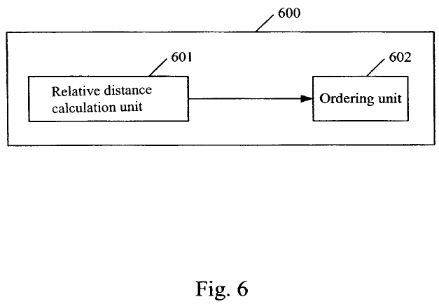

Under the same inventive concept, FIG. 6 is a schematic block diagram showing an ordering apparatus 600 for ordering a search result according to one embodiment of the present invention. This embodiment will be described in detail in conjunction with the figure.

In this embodiment, the search result is obtained by searching in hierarchical data according to a request of a search requester, and it comprises a plurality of data unit candidates from the hierarchical data. Furthermore, the hierarchical data also comprises a data unit corresponding to the search requester (hereinafter called “the data unit of the search requester”).

As shown in FIG. 6, the ordering apparatus 600 for ordering a search result of this embodiment comprises: a relative distance calculation unit 601 for calculating a relative distance between the data unit of the search requester and each of the plurality of data unit candidates according to the hierarchical data, the relative distance representing relativity between the data units in the hierarchical data; and an ordering unit 602 for ordering the plurality of data unit candidates according to the relative distances calculated in the relative distance calculation unit 601.

Specifically, after the search result comprising the plurality of data unit candidates is obtained from the hierarchical data, the relative distance calculation unit 601 calculates the relative distance between the data unit of the search requester and each of the plurality of data unit candidates as a criterion for ordering the search result. As stated in the above, the relative distance represents the relativity between the data units in the hierarchical data, and the shorter the relative distance between two data unit is, the more relative the two data units are.

Then, the ordering unit 602 orders the plurality of data unit candidates according to the relative distances calculated in the relative distance calculation unit 601. For example, the plurality of data unit candidates can be ordered in an ascending sequence based on the relative distances.

It can be seen from the above description that the ordering apparatus for ordering a search result of this embodiment can operationally realize the method for ordering a search result as shown in FIG. 1 and achieve the same effect.

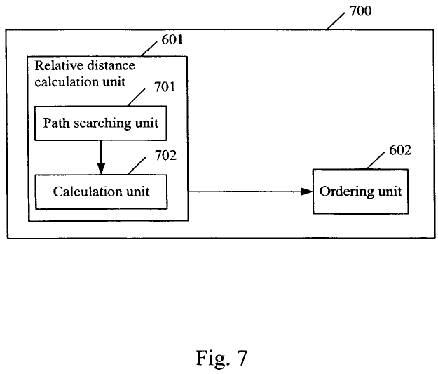

FIG. 7 is a schematic block diagram showing an ordering apparatus 700 for ordering a search result according to another embodiment of the present invention. The descriptions of the portions which are same as those of the previous embodiment are omitted properly. This embodiment will be described in detail in conjunction with the figure.

In this embodiment, when the relative distance calculation unit 601 calculates the relative distance between the data unit of the search requester and each of the plurality of data unit candidates, firstly a path searching unit 701 searches the hierarchical data for the path between the data unit of the search requester and each of the data unit candidates, and then a calculation unit 702 calculates the length of each path and the length is considered as the relative distance between the data unit of the search requester and the data unit candidate.

Then, the ordering unit 602 orders the plurality of data unit candidates in an ascending sequence based on the relative distances calculated in the relative distance calculation unit 601.

It can be seen from the above description that the ordering apparatus for ordering a search result of this embodiment can operationally realize the method for ordering a search result as shown in FIG. 2 and achieve the same effect.

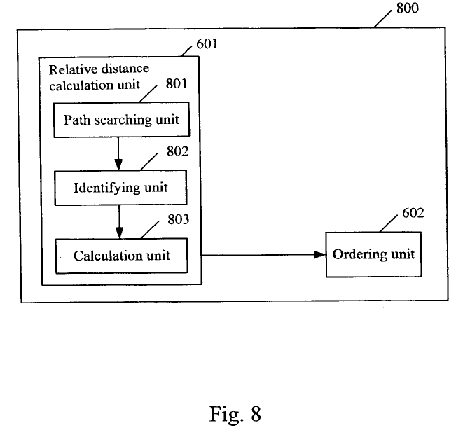

FIG. 8 is a schematic block diagram showing an ordering apparatus 800 for ordering a search result according to another embodiment of the present invention. The descriptions of the portions which are same as those of the previous embodiments are omitted properly. This embodiment will be described in detail in conjunction with the figure.

In this embodiment, when the relative distance calculation unit 601 calculates the relative distance between the data unit of the search requester and each of the plurality of data unit candidates, firstly a path obtaining unit 801 obtains the search requester path from the data unit of the search requester to the data unit at the root node and the respective paths from each of the data unit candidates to the data unit at the root node in the hierarchical data. Then an identifying unit 802 identifies the data units at the respective crossing points on which the search requester path crosses with each of the paths of the data unit candidates. And for each of the identified data units at the crossing points, a calculation unit 803 calculates the interval between the data unit of the search requester and the identified data unit as the relative distance between the data unit of the search requester and the corresponding data unit candidate.

Then, the ordering unit 602 orders the plurality of data unit candidates in an ascending sequence based on the distances calculated in the relative distance calculation unit 601.

It can be seen from the above description that the ordering apparatus for ordering a search result of this embodiment can operationally realize the method for ordering a search result as shown in FIG. 3 and achieve the same effect.

The persons skilled in the art can understand that the relative distance calculation unit 601 can employ the structure of the relative distance calculation unit in the embodiment of FIG. 7, or the structure of the relative distance calculation unit in the embodiment of FIG. 8. Certainly, the relative distance calculation unit 601 can also employ other structures according to the requirements.

Further, besides the relative distances between the data unit of the search requester and the data unit candidates, weights of the data unit candidates in the search result can be included in the criterion for ordering the search result, i.e. the search result also includes the weight corresponding to each of the plurality of data unit candidates. In this case, after the relative distance calculation unit 601 calculates the relative distances between the data unit of the search requester and the plurality of data unit candidates, the ordering unit 602 orders the plurality of data unit candidates according to the relative distances and the weights corresponding to the data unit candidates. For example, in the ordering unit 602, a weighted value can be calculated for each of the data unit candidate based on the weight of the data unit candidate and the relative distance between the data unit candidate and the data unit of the search requester. Weighting factors for the weight and the relative distance can be pre-determined. Then, the plurality of data unit candidates are ordered in an ascending sequence based on the weighted values.

Further, attributes of the data units in the hierarchical data can be included in the criterion for ordering the search result. Specifically, the above apparatus for ordering a search result further includes an attribute matching unit for searching in the plurality of data unit candidates for the data unit candidates having the same attribute as the data unit of the search requester. Then in the ordering unit 602, the data unit candidates having the same attribute as the data unit of the search requester and the remaining data unit candidates are ordered separately.

The persons skilled in the art can understand that the apparatuses 600, 700 and 800 for ordering the search result in the above embodiments can be used individually, or can be combined with the existing searching engine or directory service software.

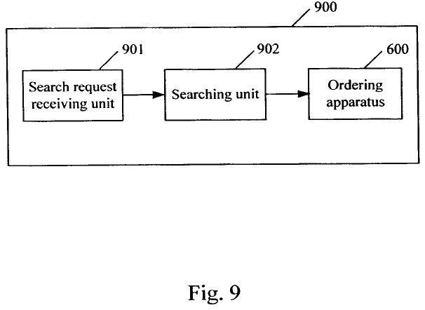

Under the same inventive concept, FIG. 9 is a schematic block diagram showing a searching engine based on hierarchical data according to one embodiment of the present invention. The descriptions of the portions which are same as those of the previous embodiment are omitted properly. This embodiment will be described in detail in conjunction with the figure.

In this embodiment, the hierarchical data comprises a data unit corresponding to a search requester, i.e. the data unit of the search requester.

As shown in FIG. 9, the searching engine 900 based on hierarchical data of this embodiment comprises a search request receiving unit 901 for receiving a search request from the search requester, the search request comprising identification information which uniquely identifies the search requester and a search criterion; a searching unit 902 for searching the hierarchical data for the data unit of the search requester corresponding to the identification information and the search result which matches the search criterion according to the search request; and an ordering apparatus 600, 700 or 800 for ordering the search result which orders the search result obtained by the searching unit 902.

Specifically, when the search requester initiates the search request, the search request receiving unit 901 receives the search request. As stated in the above, the search request includes the identification information of the search requester and the search criterion. The identification information of the search requester can be an entire name, a user ID and etc., and is used for determining the data unit corresponding to the search requester in the hierarchical data. The search request receiving unit 901 transmits the search request to the searching unit 902. The searching unit 902 searches in the hierarchical data for the data unit of the search requester according to the identification information and the search result comprising a plurality of data unit candidates according to the search criterion. And the data unit of the search requester and the search result are sent to the ordering apparatus 600, 700 or 800 to order the search result. The ordered search result is returned to the search requester in a manner of list.

The persons skilled in the art can understand that the searching engine 900 based on hierarchical data of this embodiment can be used individually, or can be combined with the directory service software.

It can be seen from the above description that the searching engine 900 based on hierarchical data of this embodiment can operationally realize the searching method based on hierarchical data as shown in FIG. 4 and achieve the same effect.

It should be pointed out that the ordering apparatus 600, 700 or 800 for ordering the search result and the searching engine 900 based on hierarchical data of the above embodiments and their components can be implemented by hardware circuit such as Very Large Scale Integrated Circuit or gate array, semiconductor such as logic chips and transistors, or programmable hardware device such as field programmable gate array, programmable logic device, and by software executing on various types of processors, and by the combination of above hardware circuit and software.

Although the method and apparatus for ordering the search result, the searching method and searching engine based on hierarchical data are described in detail in conjunction with the preferred embodiment, the present invention is not limited as above. It should be understood for the persons skilled in the art that the above embodiments may be varied, replaced or modified without departing from the spirit and the scope of the present invention.

1. A method for ordering a search result, wherein the search result comprises a plurality of data unit candidates from hierarchical data which further comprises a data unit corresponding to a search requester, the method comprising:
calculating a relative distance between the data unit of the search requester and each of the plurality of data unit candidates according to hierarchical data, the relative distance representing relativity between the data units in the hierarchical data; and
ordering the plurality of data unit candidates according to the relative distances.

2. The method according to claim 1, wherein the step of calculating a relative distance between the data unit of the search requester and each of the plurality of data unit candidates comprises:
searching in the hierarchical data for a path between the data unit of the search requester and each of the plurality of data unit candidates; and
calculating a length of each path as the relative distance between the data unit of the search requester and each of the plurality of data unit candidates.

3. The method according to claim 1, wherein the step of calculating a relative distance between the data unit of the search requester and each of the plurality of data unit candidates comprises:
obtaining a search requester path from the data unit of the search requester to the data unit at a root node in the hierarchical data;
obtaining a path from each of the plurality of data unit candidates to the data unit at the root node in the hierarchical data;
identifying a data unit at a crossing node on which the search requester path crosses with each of the paths of the plurality of the data unit candidates; and
calculating an interval between the data unit of the search requester and the identified data unit at the crossing node as the relative distance between the data unit of the search requester and the corresponding data unit candidate.

4. The method according to claim 1, wherein the search result further includes a weight corresponding to each of the plurality of data unit candidates; and
wherein the step of ordering the plurality of data unit candidates comprises:
ordering the plurality of data unit candidates based on the respective relative distances between the data unit of the search requester and each of the plurality of data unit candidates and the respective weights corresponding to each of the plurality of data unit candidates.

5. The method according to claim 1, further comprising:
searching in the plurality of data unit candidates for the data unit candidates having same attribute as the data unit of the search requester;
wherein the step of ordering the plurality of data unit candidates further comprises: ordering the data unit candidates having the same attribute as the data unit of the search requester and the remaining data unit candidates separately.

6. The method according to claim 1, wherein the hierarchical data is tree structure data.

7. An ordering apparatus for ordering a search result, wherein the search result comprises a plurality of data unit candidates from hierarchical data which further comprises a data unit corresponding to a search requester, the ordering apparatus comprising:
a relative distance calculation unit for calculating a relative distance between the data unit of the search requester and each of the plurality of data unit candidates according to the hierarchical data, the relative distance representing relativity between the data units in the hierarchical data; and
an ordering unit for ordering the plurality of data unit candidates according to the relative distances.

8. The ordering apparatus according to claim 7, wherein the relative distance calculation unit comprises:
a path searching unit for searching in the hierarchical data for a path between the data unit of the search requester and each of the plurality of data unit candidates; and
a calculation unit for calculating a length of each path as the relative distance between the data unit of the search requester and each of the plurality of data unit candidates.

9. The ordering apparatus according to claim 7, wherein the relative distance calculation unit comprises:
a path obtaining unit for obtaining a search requester path from the data unit of the search requester to the data unit at a root node in the hierarchical data and a path from each of the plurality of data unit candidates to the data unit at the root node in the hierarchical data;
an identifying unit for identifying a data unit at a crossing point on which the search requester path crosses with each of the paths of the plurality of the data unit candidates; and
a calculation unit for calculating an interval between the data unit of the search requester and the identified data unit at the crossing point as the relative distance between the data unit of the search requester and the corresponding data unit candidate.

10. The ordering apparatus according to claim 7, wherein the search result further includes a weight corresponding to each of the plurality of data unit candidates;
the ordering unit is configured to order the plurality of data unit candidates based on the respective relative distances between the data unit of the search requester and each of the plurality of data unit candidates and the respective weights corresponding to each of the plurality of data unit candidates.

11. The ordering apparatus according to claim 7, further comprising:
an attribute matching unit for searching in the plurality of data unit candidates for the data unit candidates having same attribute as the data unit of the search requester;
wherein the ordering unit is configured to order the data unit candidates having the same attribute as the data unit of the search requester and the remaining data unit candidates separately.

12. The ordering apparatus according to claim 7, wherein the hierarchical data is tree structure data.

13. A searching method based on hierarchical data, wherein the hierarchical data comprises a data unit corresponding to a search requester, the searching method comprising:
receiving a search request from the search requester, the search request comprising identification information which uniquely identifies the search requester and a search criterion;
searching in the hierarchical data for the data unit of the search requester corresponding to the identification information and a search result matching the search criterion based on the search request; and
ordering the search result by using the method for ordering a search result.

14. A searching engine based on hierarchical data, wherein the hierarchical data comprises a data unit corresponding to a search requester, the searching engine comprising:
a search request receiving apparatus for receiving a search request from the search requester, the search request comprising identification information which uniquely identifies the search requester and a search criterion;
a searching apparatus for searching in the hierarchical data for the data unit of the search requester corresponding to the identification information and a search result matching the search criterion based on the search request; and
an ordering apparatus for ordering a search result.
